(19) United States
(12) Patent Application Publication
(10) Pub. No.: US 2013/0027994 A1
(43) Pub. Date: Jan. 31, 2013

(54) Method and system for damping subsynchronous resonant oscillations in a power system using a wind turbine

(71) Applicants: Robert J. Nelson, Orlando, FL (US); Hongtao Ma, Orlando, FL (US)

(72) Inventors: Robert J. Nelson, Orlando, FL (US); Hongtao Ma, Orlando, FL (US)

(73) Assignee: SIEMENS AKTIENGESELLSCHAFT, Munich (DE)

(21) Appl. No.: 13/577,672

(22) PCT Filed: Mar. 8, 2011
(86) PCT No.: PCT/US2011/027530

§ 371 Date: Sep. 25, 2012

Related U.S. Application Data
(60) Provisional application No. 61/312,776, filed on Mar. 11, 2010.

(51) Int. Cl. H02M 1/12

(52) U.S. Cl. 363/40

(57) ABSTRACT

A wind turbine controlled to damp subsynchronous resonance oscillations on a grid is provided. The wind turbine includes rotor blades for turning by the wind, an electric generator rotatably coupled to the rotor blades, a power converter responsive to electricity generated by the electric generator, the power converter for converting the generated electricity to a frequency and voltage suitable for supply to the power grid, and the power converter for regulating voltage on the grid for damping the subsynchronous oscillations. Additionally, in one embodiment voltage regulation is supplemented by modulating real power to damp the subsynchronous oscillations.

This application claims benefit of the Mar. 11, 2010 filing date of U.S. Application No. 61/312,776, which is incorporated by reference herein.

### FIELD OF THE INVENTION

The present invention relates generally to control of power systems and more specifically to damping subsynchronous resonance oscillations by employing a full-conversion or a partial conversion wind turbine, the latter also referred to as a doubly-fed induction generator or DFIG.

### BACKGROUND OF THE INVENTION

In power transmission systems, series capacitors are used as an effective technique for increasing power transfer capability, improving transient and steady state stability, reducing rapid voltage fluctuations, and reducing line losses. These benefits are achieved because the series-connected capacitors partially compensate the inductive reactance of the transmission lines. However, the use of series capacitors may promote subsynchronous resonant (SSR) oscillations in the power system as a series compensated transmission line inevitably has a lower electrical resonant frequency than the system electrical operating frequency. When created, these SSR oscillations may cause damage to turbine-generator shafts and components attached to the shaft. The causes and consequences of subsynchronous resonance are exacerbated by the continued growth of power transmission system interconnections.

SSR oscillations occur when the electric power system exchanges energy with the turbine-generators (including high and low pressure turbines, the generator and exciter all sharing a common shaft) at one or more frequencies below the electrical system synchronous frequency (thus the term “subsynchronous). The SSR oscillations within the generator are produced when a disturbance-caused system electrical resonant frequency is close to a natural torsional mode (mechanical) frequency of the turbine-generator shaft. The series compensated line with its lower electrical resonant frequency interacts with the torsional natural frequency of the synchronous generator, exciting the subsynchronous oscillations in the generator. Even small magnitude disturbances in the electrical power system can create subsynchronous resonance oscillations in the turbine-generator.

When a torsional oscillation mode is excited by the SSR oscillations, the rotor of the synchronous generator acts like an induction generator rotor operating at the “slip” frequency, where the slip frequency is the difference between the system frequency and the SSR frequency. This action amplifies the SSR oscillating currents and causes the turbine-generator shaft to oscillate at its natural torsional frequency. Within seconds, these undamped resonant oscillations may increase to an endurance limit of the shaft, resulting in shaft fatigue and possibly damage and failure.

The power transfer capacity of a transmission line is proportional to V²/X_{L}, where V is the voltage and X_{L} is the inductive reactance of the line. If a series capacitor is introduced into the line, the power transfer capacity is V²/(X_{L}−X_{C}), where X_{C} is the reactance of the series capacitor. If the series capacitive reactance is half of the series inductive reactance, the power transfer capacity doubles. But an increase in power transfer capability comes at the expense of creating an electrical resonant frequency equal to 60×(√(X_{C}/X_{L})) in a 60 Hz system.

For example, a line that has 70% ratio series compensation (i.e., X_{C}/X_{L}=0.7) has a resonant frequency of roughly 50 Hz (i.e., 60×√(0.7)=50.2). To a generator rotor, this appears to be a pair of frequencies of roughly 10 Hz and 70 Hz (i.e., a difference in frequency between the system electrical frequency and the mechanical resonant frequency, sometimes referred to as the “slip frequency”). The supersynchronous frequency of 70 Hz is normally damped by mechanical system components, but the low frequency (subsynchronous frequency of 10 Hz) is only lightly damped and may grow if excited by continual system subsynchronous oscillations. If a generator rotor torsional natural frequency is at this subsynchronous slip frequency the torsional mode is excited, generating additional SSR currents at the subsynchronous slip frequency and creating a positive feedback situation (i.e., more SSR current creating larger oscillations, etc.). These oscillations can impose high magnitude excitations on the generator shaft ultimately causing damage to the shaft or the rotor due to torsional fatigue (excessive twisting).

At a New Mexico plant in 1970, connected to a roughly 90% series compensated transmission line, the SSR oscillations were sufficiently intense to physically break the generator shaft, causing significant damage to the turbine and generator. SSR oscillations have also caused damage to doubly-fed induction generator (DFIG) wind turbines in Texas. Like synchronous generators, these induction generators have torsional natural frequencies and therefore respond to subsynchronous excitations. When the grid electrical resonant frequency coincides with or is close to an SSR frequency, induction generator can go into a self-excited mode of operation, resulting in high subsynchronous current flows.

In addition to mechanical torsional interactions, it is possible for electronic controllers to have control interactions with the power system, causing subsynchronous current flows and voltages on the power system. This is sometimes called SSCI (subsynchronous control interaction) to distinguish it from SSTI (subsynchronous torsional interaction). Both are considered categories of SSR oscillations.

Actual and potential damage resulting from the effects of these SSR oscillations have discouraged electric utilities from using series capacitor compensation with synchronous generators. In fact, for several years after the New Mexico incident the utility industry throughout the world largely stopped installing new series capacitors to compensate series inductive reactance. Instead, utilities installed new transmission lines (because of the inability to extend the capability of existing lines by using series capacitor compensation) or found ways to exercise existing lines to higher capability.

Utilities began using FACTS (Flexible AC Transmission System) controllers, including static synchronous compensators (STATCOMS) to control SSR oscillations. As a result of these efforts to reduce SSR oscillations, the use of series capacitor compensation appears to be staging a comeback, in particular in Texas and the western US.

FACTS controllers control both real and reactive power flow on a transmission line. Since STATCOMS (one class of FACTS controllers) were developed in the early 1990s by Westinghouse Electric Corporation, several schemes have been developed using STATCOMs to damp SSR oscillations. One technique is described in a paper entitled, “A Novel Approach for Subsynchronous Resonance Damping Using a STATCOM” by Rai, et al., which was presented at the Fifteenth National Power Systems Conference in Bombay, India in December 2008.

The SSR oscillations are a 3-phase balanced voltage set. Therefore, another technique employs a shunt-connected STATCOM controller to deliberately introduce a phase voltage imbalance (by introducing an asymmetrical voltage) to reduce the electromechanical coupling between the electrical and mechanical components of the turbine-generator. The reduced coupling reduces the exchange of energy between the electrical and mechanical components and limits the effects of the SSR oscillations.

Other FACTS-based devices and techniques to damp SSR oscillations include: thyristor-controlled series compensators, the NGH series damper and solid state series compensators (SSSC). These devices are expensive and difficult to operate and control. Further, they must be protected from the effects of short circuits and the attendant short circuit current they are subjected to.

Commonly-owned U.S. Pat. No. 4,438,386 employs a static VAR generator that controllably connects reactive components (e.g., inductors) to the power system to reduce SSR oscillations. The static VAR generator comprises thyristors in series with the reactive components that control the connection of these reactive components to the power system. By controlling the conduction angle (i.e., the start and duration of thyristor conduction) of each thyristor and inserting the reactive components into the power system at the appropriate times, the SSR oscillations are reduced.

It is theoretically possible to sense SSR voltages and currents on local or, to a lesser extent, remote interconnecting transmission lines or generators and generate a voltage and current to eliminate the SSRs. One recent paper, “Mitigation of Subsynchronous Oscillations by 48-Pulse VSC STATCOM Using Remote Signal” by Salemnia, et al., presented at the 2009 Bucharest IEEE Power Conference, describes SSR damping by a STATCOM based on a signal from a remote generator.

Due to current efforts to reduce consumption of natural resources, the conversion of wind energy to electrical energy using wind turbine generators is becoming more prevalent. Wind turbines exploit wind energy by converting the wind energy to electricity for distribution to end users.

A fixed-speed wind turbine is typically connected to the grid through an induction (asynchronous) generator for generating real power. Wind-driven blades drive a rotor of a fixed-speed wind turbine that in turn operates through a gear box (i.e., a transmission) at a fixed rotational speed. The fixed-speed gear box output is connected to the induction generator for generating real power. The rotor and its conductors rotate faster than the rotating flux applied to the stator from the grid (i.e., higher than the synchronous field frequency). At this higher speed, the direction of the rotor current is reversed, in turn reversing the counter EMF generated in the rotor windings, and by generator action (induction) causing current (and real power) to be generated in and flow from the stator windings. The frequency of the generated stator voltage is the same as the frequency of the applied stator voltage providing the excitation. The induction generator may use a capacitor bank for reducing reactive power consumption (i.e., the power required to generate the stator flux) from the power system.

The fixed-speed wind turbine is simple, reliable, low-cost and proven. But its disadvantages include uncontrollable reactive power consumption (as required to generate the stator rotating flux), mechanical stresses, limited power quality control and relatively inefficient operation. In fact, wind speed fluctuations result in mechanical torque fluctuations that then result in fluctuations in the electrical power on the grid.

In contrast to a fixed-speed wind turbine, the rotational speed of a variable speed wind turbine can continuously adapt to the wind speed, with the blade speed maintained at a relatively constant value corresponding to a maximum electrical power output through the use of a gear box disposed between the wind turbine rotor and the generator rotor. The variable speed wind turbine may be of a doubly-fed induction generator (DFIG) design or a full converter design. The doubly-fed induction generator uses a partial converter to interchange power between the wound induction generator rotor and the power system. The full converter wind turbine is typically equipped with a synchronous or asynchronous generator (the output of which is a variable frequency AC based on the wind speed) and connected to the grid through a power converter that rectifies the incoming variable AC to DC and inverts the DC to a fixed-frequency 60 Hz AC. Variable-speed wind turbines have become widespread due to their increased efficiency over fixed-speed wind turbines and superior ancillary service capabilities.

The present invention utilizes the growing availability of variable speed wind turbine systems to counter the effects of SSR oscillations by damping these oscillations on an electrical transmission system, and a method related thereto.

### BRIEF DESCRIPTION OF THE DRAWINGS

The invention is explained in the following description in view of the drawings that show:

FIG. 1 is a block diagram of a prior art variable speed wind turbine system.

FIG. 2 is a block diagram of a prior art power electronics system of FIG. 1.

FIG. 3 is a line diagram of an electrical power system to which the teachings of the present invention can be applied.

FIGS. 4 and 5 are block diagrams of wind turbines to which the teachings of the present invention can be applied.

FIGS. 6 and 7 are block diagrams of controllers according to the present invention.

### DETAILED DESCRIPTION OF THE INVENTION

Before describing in detail the particular methods and apparatuses related to SSR oscillation damping in a power system in accordance with various aspects of the present invention, it should be observed that the present invention, in its various embodiments, resides primarily in a novel and non-obvious combination of hardware, method steps and software elements related to said method and apparatus. Accordingly, the hardware, method steps and software elements have been represented by conventional elements in the drawings, showing only those specific details that are pertinent to the present invention so as not to obscure the disclosure with structural details that will be readily apparent to those skilled in the art having the benefit of the description herein.

The following embodiments are not intended to define limits of the structures or methods of the invention but only to provide exemplary constructions. The embodiments are permissive rather than mandatory and illustrative rather than exhaustive.

The present invention relates to the use of wind turbines to reduce or damp SSR oscillations in a power system.

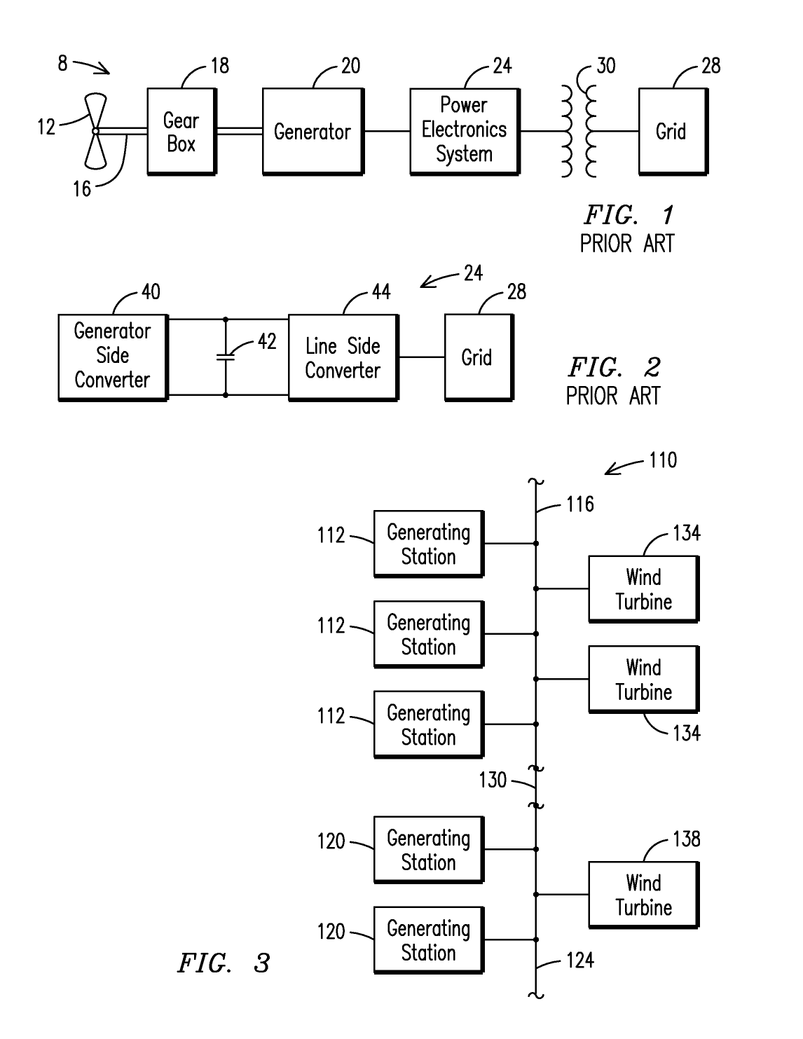

FIG. 1 illustrates components of an exemplary variable-speed wind turbine 8, including rotor blades 12 for converting wind energy to rotational energy for driving a shaft 16 connected to a gearbox 18. The wind turbine also includes a structural support component, such as a tower and a rotor pointing mechanism, not shown in FIG. 1. The gearbox 18 converts low speed rotation to high speed rotation, as required for driving a generator 20 to generate electricity. Typically a plurality of wind turbines 8 are sited at a common location, referred to as a wind turbine park.

Electricity generated by the generator 20 is supplied to a power electronics system 24 to adjust the generator output voltage and/or frequency for supply to a grid 28 via a step-up transformer 30. The low-voltage side of the transformer 30 is connected to the power electronics system 24 and the high-voltage side to the grid 28. The power electronics system 24 is controllable to impart characteristics to the generated electricity as required to match or modify characteristics of the electricity flowing on the grid 28. According to the present invention, the power electronics system 24 can control active power flow and/or voltage regulation to reduce the SSR oscillations on the grid 28.

Different generators 20 are used for different wind turbine applications, including both asynchronous (induction) generators (e.g., squirrel cage, wound rotor and doubly-fed induction generators) and synchronous generators (e.g., wound rotor and permanent magnet synchronous generators). Advantageously, the induction generators are relatively simple and inexpensive, but disadvantageously the stator requires a reactive magnetizing current and therefore consumes reactive power from the grid.

In the doubly-fed induction generator (DFIG), utility grid supplied electricity (typically three phase AC) energizes the windings of the generator stator. The wind-driven blade assembly of the wind turbine generates the mechanical force to turn the rotor shaft, such as through the gear box. The magnetizing current and the low frequency (slip) power are supplied to the rotor from a rotor converter. The rotor converter controls the active and reactive power by controlling the rotor current components. The DFIG is typically used when the power electronics system comprises a partial converter (typically about one-third the capacity of a full converter).

The power electronics system 24 employs different elements for different turbine-generator installations and applications, including rectifiers, inverters and frequency converters (e.g., back-to-back, multilevel, tandem, matrix and resonant converters).

One type of converter, referred to as a full converter or back-to-back converter, employed in a variable speed wind turbine comprises a power converter connected to the generator side, a DC link and a power converter connected to the grid side. The full converter converts an input voltage, i.e., a fixed frequency alternating current, a variable frequency alternating current (due to variable wind speed) or a direct current, as generated by the wind turbine, to a desired output frequency and voltage as determined by the grid that it supplies. Typically using insulated gate bipolar transistors (IGBTs), the generator-side converter converts the electricity produced by the generator to DC and transfers this energy to the DC link. From the DC link the electricity is supplied to the grid-side active converter where it is transformed to fixed frequency AC electricity and supplied to the grid.

One embodiment of a full converter, illustrated in FIG. 2, includes a generator-side converter 40 for converting the generated AC electricity to DC and an output capacitor 42 for filtering the DC current. DC current is supplied to a line side converter 44 (inverter) for producing 60 Hz AC power supplied to the grid 28. The amount of power available from the wind turbine is determined by operation of the generator-side converter.

The present invention relates to the use of a wind turbine to damp SSR oscillations on the grid. A line side converter (as an element of the full converter illustrated in FIG. 2) can provide the same functionality as a STATCOM, and can further generate real power when the wind turbine is active. A true STATCOM can generate or absorb only reactive power to damp SSR oscillations; it cannot generate or inject real power. Since a full-converter wind turbine possess all of the voltage regulation attributes of a STATCOM, and unlike a STATCOM can also produce real power, a full converter wind turbine can provide effective damping of SSR oscillations; perhaps better damping than a STATCOM operating alone. The capability to provide reactive power from the line side converter is available at all times when the wind turbine is on-line and the real-power damping supplementary capability is available when the wind turbine is generating real power.

A large number of series-compensated transmission lines are now being built in the western US to accommodate power generation from renewable energy resources. Concerns about SSTI (subsynchronous torsional interacts) and SSCI (subsynchronous control interactions) are of increased importance, particularly when type 3 generators (DFIG generators) connect the generator with the transmission system. Like synchronous generators, induction generators have torsional oscillatory modes that can be excited by SSR oscillations and can result in similar instabilities to those described above for synchronous machines. A generator, such as a wind turbine, that generates power from a renewable resource and can also actively damp SSR oscillations is especially beneficial. Additionally, use of the wind turbine to damp SSR oscillations avoids expenses associated with the use of separate FACTS controllers to damp the SSR oscillations.

The present invention provides a new, non-obvious and useful wind turbine and a method for using a wind turbine to effectively damp SSR oscillations using either voltage regulation alone (when the wind turbine is on-line but not producing real power) or voltage regulation supplemented by active power control (when the turbine is producing active or real power). The invention can actively damp SSR voltages, currents, and/or power oscillations based upon local or remote voltage, current, or power measurements. However, it is recognized that due to the distance to remote SSR oscillations, it may not be possible to effectively suppress such remote oscillations. According to one embodiment, the SSR-damping functionality of the wind turbine is active only when SSR oscillations have been detected locally or remotely.

The invention implements SSR oscillation damping functionality in the controls of the wind turbine system-side converter (also referred to as the line-side converter), using either the voltage capability only (when the turbine is on-line, irrespective of whether it is producing real power, for example when the wind turbine outputs are curtailed because there is inadequate wind for real power production) or voltage control supplemented by active power control (when the turbine is producing real power). Control signals are supplied to the line side converter by an auxiliary signal to the voltage regulation controller to control this functionality.

In one application, the injection of real power may entail injecting a negative sequence component into the power system to induce a voltage imbalance, i.e. because the voltages have different magnitudes or the voltages are not 120 degrees out of phase from each other oscillation damping is increased

The wind turbine control strategy, as embodied in its control algorithms, should be sufficiently general to accommodate various controls that are used to implement SSR oscillation damping.

As long as wind turbines are sited on the fringes of a power system, where most tend to be located today, they may not be ideally located to provide SSR oscillation damping since they may not be located proximate or between large generating stations. But as they become more prevalent, wind turbines may be sited near or between major generating stations, for example with a secondary motivation to reduce SSR oscillations. For example, in the western United States, where large hydroelectric and coal plants are employed to generate electricity, wind farms (i.e., a collection of wind turbines) may be established between these generating stations. Furthermore, SSR oscillation damping using wind turbines may become a required capability once this functionality is generally known.

FIG. 3 illustrates a power system to which the teachings of the present invention can be applied. FIG. 3 is a single-line schematic diagram of an electrical power system or power grid 110 including generating stations 112 supplying electricity to a transmission line 116 (via intermediate transformers and associated equipment not shown). Generating stations 120 supply electricity to a transmission line 124 also via intermediate transformers and associated equipment not shown in FIG. 3. The transmission lines 116 and 124 are interconnected through a transmission tie line 130. Wind turbines 134 supply power to the transmission line 116 and a wind turbine 138 supplies power to the transmission line 124.

According to one embodiment of the invention, each of the wind turbines 134 and 138 comprises a full converter wind turbine that appears, from the perspective of the power grid 110, to be either a voltage control device that is not supplying real energy (such as during a curtailment when the wind turbine is not producing real power but is available for regulating the system voltage) or a voltage control device that supplies real energy (such as when the wind turbine is producing power for the grid). The full converter can thus regulate voltage independently of producing real power, as voltage regulation requires no real energy other than to compensate for real resistive losses. Thus without producing real power, the full converter can modulate a phase angle of the measured SSR voltage to generate an output voltage with a phase angle that effectively damps the SSR oscillations on the power grid.

Consequently, in addition to supplying real power to the power grid 110, a suitably controlled wind turbine 134 or 138 can provide an ancillary function of damping SSR oscillations. If the wind turbine 134 or 138 is not generating real power it can use voltage (voltage phase angle) regulation to damp SSR oscillations. If the wind turbine 134 or 138 is generating real power it can use voltage regulation supplemented by real power regulation to damp the SSR oscillations.

According to the present invention, the phase angle of the voltage is controlled to damp SSR oscillations (whether the wind turbine is producing real power for the grid) and that voltage is injected back into the grid to reduce the SSR oscillations. In fact, if the transmission system was ideal, i.e., purely reactive with no resistance, this technique would be sufficient. But all real transmission systems have real resistances and thus the SSR voltages cannot be perfectly cancelled unless real power is injected into the system with the correcting voltage.

In yet another embodiment the wind turbine 134 or 138 includes an energy storage device, e.g., a battery, super-capacitor, a superconducting magnetic energy storage device, allowing the wind turbine to exercise voltage control supplemented by real power control, with the real power supplied from the storage device when the wind turbine is not generating real power.

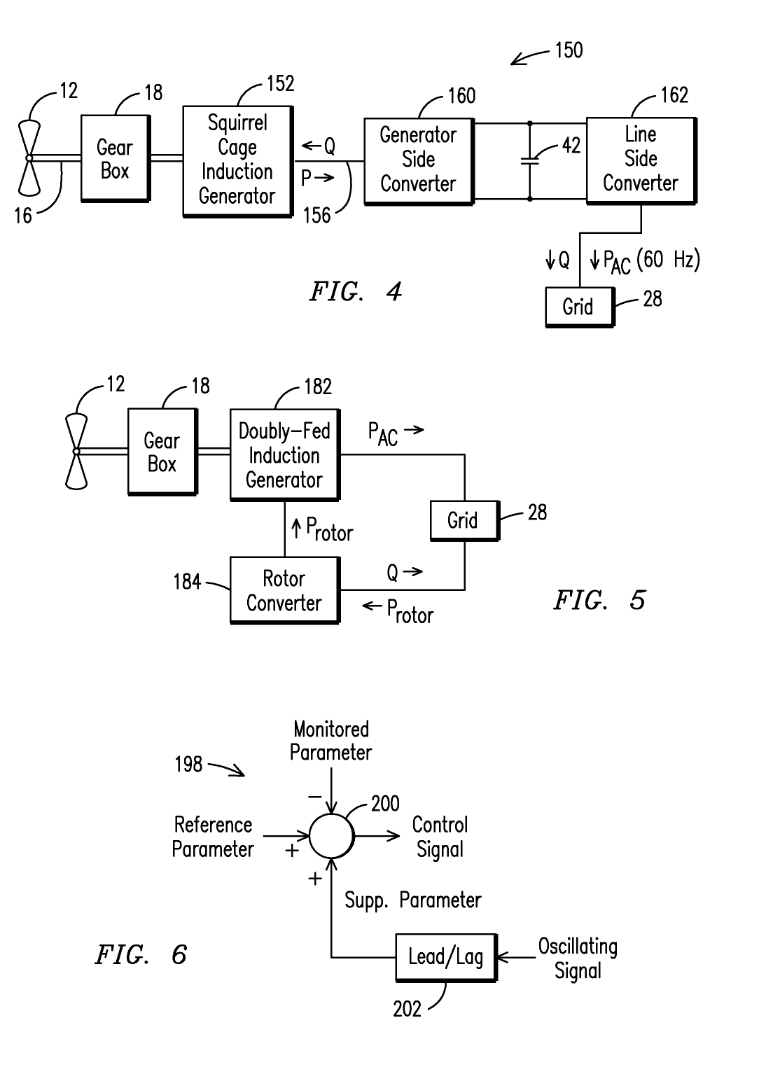

FIG. 4 illustrates a wind turbine 150 comprising a squirrel cage induction generator 152 (or another type of induction generator) that consumes but cannot produce magnetizing current. Thus a conductor 156 extending from the generator 152 receives magnetizing current from a generator side converter 160 and supplies real power P (at a variable frequency dependent on the rotational speed of the induction generator rotor) to the generator side converter 160. The generator side converter 160 rectifies the variable frequency signal to DC. The DC power is supplied to a line-side converter 162 that outputs real power (P) at 60 Hz and regulates system voltage.

If one of the wind turbines 134 and 138 of FIG. 3 is configured as the wind turbine 150 of FIG. 4 the output of the line side converter 162 can be used to damp SSR oscillations on the transmission lines 116 and 124 and the tie line 130 of FIG. 3. The SSR oscillations are damped by controlling one or more of the real output power (P_{AC}) or the output voltage. It is noted that changing the output voltage of the wind turbine changes the real output power.

A synchronous generator (such as a permanent magnet synchronous generator) can be substituted for the induction generator 152 with the same inventive results. But the generator side converter 160 can be simplified when used with the synchronous generator as it is not required to provide magnetizing current to the generator.

FIG. 5 illustrates another wind turbine design including a doubly-fed induction generator (DFIG) 180, with a rotor converter 184 supplying power (Pᵣₒₜₒᵣ) to a rotor winding of the DFIG 180. A stator of the DFIG 180 connects directly to the grid 28. The rotor converter 184 may also generate reactive power Q as illustrated, without providing real power. The rotor converter is typically about one-third the size of a generator-side or line-side converter used in other described wind turbine systems.

As known by those skilled in the art, several algorithms have been developed for use with STATCOMs (or other FACTS devices) to identify and damp SSR oscillations. These algorithms, or the concepts embodied therein, can also be employed with the line side converter to damp these same SSR oscillations. Execution of the algorithms determines the existence of SSR oscillations and the amount of reactive power the wind turbine should inject or remove from the system or the amount of real power the wind turbine should inject into the power system to limit or eliminate the SSR oscillations before any turbines-generators on the grid sustain damage.

One algorithm uses either a local signal or a remote signal that indicates the occurrence of SSR oscillations. It is expected that this feature would typically be employed only when the connecting transmission line is equipped with a series capacitor or a power electronic controller (such as an HVDC terminal) and therefore SSR oscillations may occur.

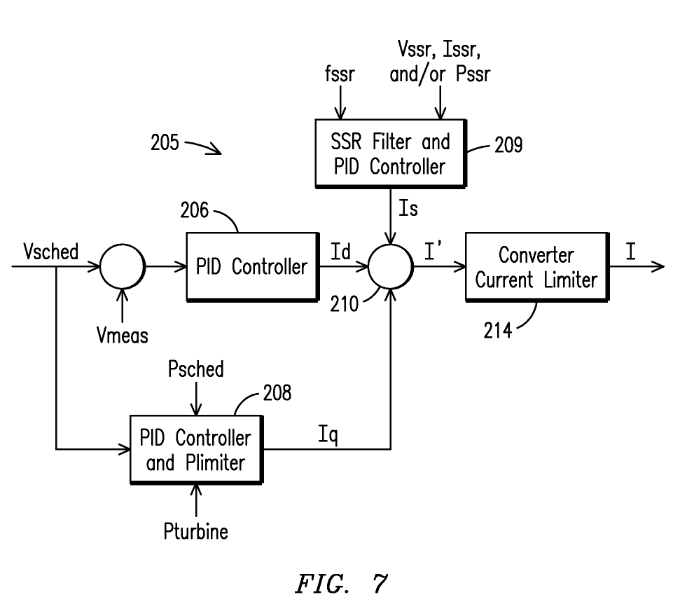

A controller 198 for controlling the line side converter (FIG. 4) or rotor converter (FIG. 5) is described with reference to FIG. 6. A reference value of a regulated parameter (e.g., a voltage, current or another parameter that the controller 198 regulates) is input to a summer 200. A monitored (controlled) parameter and a supplemental parameter are also input to the summer 200. A lead/lag term may be associated with the supplemental parameter as indicated, that is, a lead/lag functional block 202 may be used to adjust the phase of the signal, as needed. The resulting combined signal, referred to as a control signal in FIG. 6, is input to a voltage regulation network. For example, the control signal may control a voltage regulator to produce a desired voltage signal to damp the undesired SSR oscillations.

Another controller 205 employing a different control scheme (algorithm) is illustrated in FIG. 7. As described further below, the PID controllers (proportional integral derivative controllers) in FIG. 7 both damp the SSR oscillations according to the present invention and produce an output current to regulate voltage on the power system.

The variable names referred to in FIG. 7 are defined below.

Vsched=scheduled line voltage

Vmeas=actual line voltage

Pturbine=actual active power generated by the turbine

Psched=scheduled active power to be generated by the turbine

Id=reactive current component as produced by a PID controller 206.

Iq=active current component as produced by a PID controller and power limiter 208.

(Note in this example the dq reference frame is rotated 90 degrees counterclockwise so the total current is I=Iq−j*Id. This reference frame provides some calculation simplifications since certain reactive current calculations can therefore be performed without the “j” term.)

fssr=subsynchronous frequency (as measured either locally or remotely) input to an SSR filter and PID controller 209.

Issr, Vssr, Pssr=subsynchronous components of the voltage, current and power also input to the SSR filter and PID controller 209.

The SSR filter and PID controller 209, operating according to known control algorithms, produces the current component Is required to damp the SSR oscillations.

I′=Is+Id+Iq. The three current components are combined in a combiner 210 to generate a current I′, which is input to a converter current limiter 214. An output current I from the converter current limiter 214 is the total output current demand signal input to the wind turbine converter voltage regulation controller. Since the total current I includes the SSR damping component Is, the SSR oscillations are reduced or damped by the wind turbine converter voltage regulation controller, which injects reactive power to regulate voltage on the power system and real and/or reactive power to damp the SSR oscillations. The converter injects a voltage to cancel the SSR voltage on the system, adjusting its output magnitude and phase to minimize the SSR oscillations. As is well understood by those familiar with the state of the art, I′, Is, Id, and Iq are phasor quantities and add algebraically, not arithmetically.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A variable speed wind turbine comprising:
rotor blades for turning by wind;
an electric generator rotatably coupled to the rotor blades for generating electricity; and
a power converter responsive to the electricity generated by the electric generator for converting the electricity to a frequency and voltage suitable for supplying to a power system grid, the power converter further responsive to subsynchronous resonance oscillations on the power system grid and effective to damp the oscillations by regulating the voltage supplied to the grid.

2. The wind turbine of claim 1 wherein the power converter comprises one of a full conversion power converter and a partial conversion power converter.

3. The wind turbine of claim 1 wherein the electric generator comprises one of a doubly fed induction generator, an induction generator and a synchronous generator.

4. The wind turbine of claim 1 wherein the power converter is responsive to a control signal indicative of the subsynchronous resonance oscillations on the grid.

5. The wind turbine of claim 1 wherein the power converter regulates the voltage on the grid by supplying reactive power to the grid or by drawing reactive power from the grid effective to damp the subsynchronous resonance oscillations.

6. The wind turbine of claim 5 wherein the power converter regulates the voltage on the grid by modulating real power on the grid when the turbine is producing real power.

7. The wind turbine of claim 1 further comprising an energy storage device, wherein the power converter regulates voltage on the grid supplemented by real power control when the wind turbine is not generating real power, the energy storage device supplying real power.

8. The wind turbine of claim 1 wherein the power converter regulates voltage on the grid when the turbine is on-line, irrespective of whether the wind turbine is producing real power.

9. The wind turbine of claim 1 wherein the power converter comprises a line side power converter, the wind turbine further comprising a generator side power converter.

10. The wind turbine of claim 1 wherein the subsynchronous resonance oscillations comprise one or both of subsynchronous control interactions and subsynchronous torsional interactions.

11. A method for minimizing subsynchronous resonance oscillations on a grid of a power system, the method comprising:
generating electricity by rotation of an electric generator rotatably coupled to rotor blades of a wind turbine, wherein wind energy causes rotation of the rotor blades;
converting the electricity to a frequency and voltage suitable for supply to the grid by action of a power converter; and
the power converter regulating a grid voltage effective to damp the subsynchronous resonance oscillations.

12. The method of claim 11 wherein regulating the grid voltage effective to damp the oscillations comprises one of a full conversion power converter and a partial conversion power converter regulating the grid voltage effective to damp the oscillations.

13. The method of claim 11 wherein generating electricity by rotation of an electric generator comprises generating electricity by rotation of one of a doubly fed induction generator, an induction generator and a synchronous generator.

14. The method of claim 11 wherein regulating the grid voltage effective to damp the subsynchronous resonance oscillations is responsive to a control signal indicative of the subsynchronous resonance oscillations on the grid.

15. The method of claim 11 wherein regulating the grid voltage further comprises modulating real power on the grid when the wind turbine is producing real power, and wherein regulating the grid voltage further comprises supplying reactive power to the grid and drawing reactive power from the grid when the wind turbine is not producing real power.

16. The method of claim 11 wherein regulating the grid voltage further comprises regulating the grid voltage when the wind turbine is on-line, irrespective of whether the wind turbine is producing real power.

17. The method of claim 11 wherein regulating the grid voltage further comprises supplying reactive power to the grid or drawing reactive power from the grid effective to damp the subsynchronous resonance oscillations.

18. The method of claim 11 further comprising storing energy in an energy storage device, the power converter effective to regulate the grid voltage when the wind turbine is not producing real power using energy from the energy storage device.

19. The method of claim 11 wherein regulating the grid voltage effective to damp the subsynchronous resonance oscillations further comprises regulating the grid voltage effective to damp one or both of subsynchronous control interactions and subsynchronous torsional interactions.
